(19) United States
(12) Patent Application Publication
(10) Pub. No.: US 2016/0377243 A1
(43) Pub. Date: Dec. 29, 2016

(54) Flex Light

(71) Applicants: Thomas J. Mercer, Edmond, OK (US); Justin Misner, Edmond, OK (US)

(72) Inventors: Thomas J. Mercer, Edmond, OK (US); Justin Misner, Edmond, OK (US)

(21) Appl. No.: 14/747,494

(22) Filed: Jun. 23, 2015

(51) Int. Cl. F21L 4/04; F21L 4/08; F21V 23/04; F21L 4/02

(52) U.S. Cl. CPC F21L 4/04; F21L 4/02; F21L 4/08; F21V 23/0421

(57) ABSTRACT

A lighted rod apparatus comprising a power unit having at least one switch, and least one power source, an elongated shaft having a leading end, a tail end, an elongated section between the ends, the section including at least a rigidly flexible shaft, and a passage defined within the section, at least one light source electrically connected to the power unit and adapted to externally illuminate substantially all of the section and a tip, whereby the lighted rod can be easily shaped to a desired form to illuminate difficult areas and can be manipulated to penetrate areas difficult to illuminate.

### CROSS-REFERENCE TO RELATED APPLICATIONS

None.

### FIELD OF THE INVENTION

The invention relates to a flexible light apparatus for providing light in hard to light areas. More particularly, the invention relates to an apparatus that provides light along the length of the flexible light apparatus for lighting hard to access areas such as inside a wall when electricians are pulling wires, under the hood of a car, or in a house underneath furniture.

### SUMMARY OF THE INVENTION

The invention relates to an apparatus for penetrating and lighting difficult areas. More particularly, the invention relates to an apparatus that allows a user to adapt the light to a desired configuration wherein the light remains in the desired position to light the desired area. The flex light apparatus 100 may be configured in a straight position and used as a fishing tape to penetrate unlit areas such as inside walls and extended such that it can be used for locating holes and pulling electrical wiring through walls and the attic. Traditionally, flashlights and the like may shine into hard to reach areas and only provide light in the direction of the light beam or they are too bulky to be placed in hard to reach areas. Additionally, the light beam may not fully illuminate the desired area. For example, an electrician may create a hole in the ceiling to install wiring and shine a flashlight through the hole to indicate to a second person in the attic where the hole is located. Because of the intervening insulation, the light cannot be seen by a second person. Also, prior art devices it required two people to install wiring. In general, prior art teaches various devices from simply providing localized light using luminous rods having some sort of coating that stores and emits lighting or focused lighting with fishing rods containing a screw-on lighted tip.

There have thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. Additional benefits and advantages of the present invention will become apparent in those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### DESCRIPTION OF THE DRAWINGS

FIG. 1 is a diagrammatic representation of a preferred embodiment of an extendable flex light apparatus.

FIG. 2 is a view of a flex light handle with batteries, according to a preferred embodiment of the present invention.

FIG. 3 is a view of a flex light handle with an AC to DC converter, according to an alternate embodiment of the present invention.

FIG. 4 is a view of a flex light handle with a battery charger, according to an alternate embodiment of the present invention.

FIG. 5A is a view of a flex light lighted section with threaded female connections, according to a preferred embodiment of the present invention.

FIG. 5B is a cross-section view of a flex light lighted section with threaded female connections, according to a preferred embodiment of the present invention.

FIG. 6 is a view of a flex light lighted section with threaded female and male connections, according to an alternate embodiment of the present invention.

FIG. 7 is a view of a flex light lighted section with quick disconnect female and male connections, according to an alternate embodiment of the present invention.

FIG. 8 is a side view of a flex light threaded male adapter for connecting two female sections, according to a preferred embodiment of the present invention.

FIG. 9 is a cross-sectional view of a flex light threaded male adapter for connecting two female sections, according to a preferred embodiment of the present invention.

FIG. 10 is a view of a threaded male removable tip, according to a preferred embodiment of the present invention.

FIG. 11 is a view of a threaded female removable tip, according to an alternate embodiment of the present invention.

FIG. 12 is a view of a quick disconnect female removable tip, according to an alternate embodiment of the present invention.

FIG. 13 is an electronic schematic of the lighting circuit, according to a preferred embodiment of the present invention.

### DETAILED DESCRIPTION OF THE INVENTION

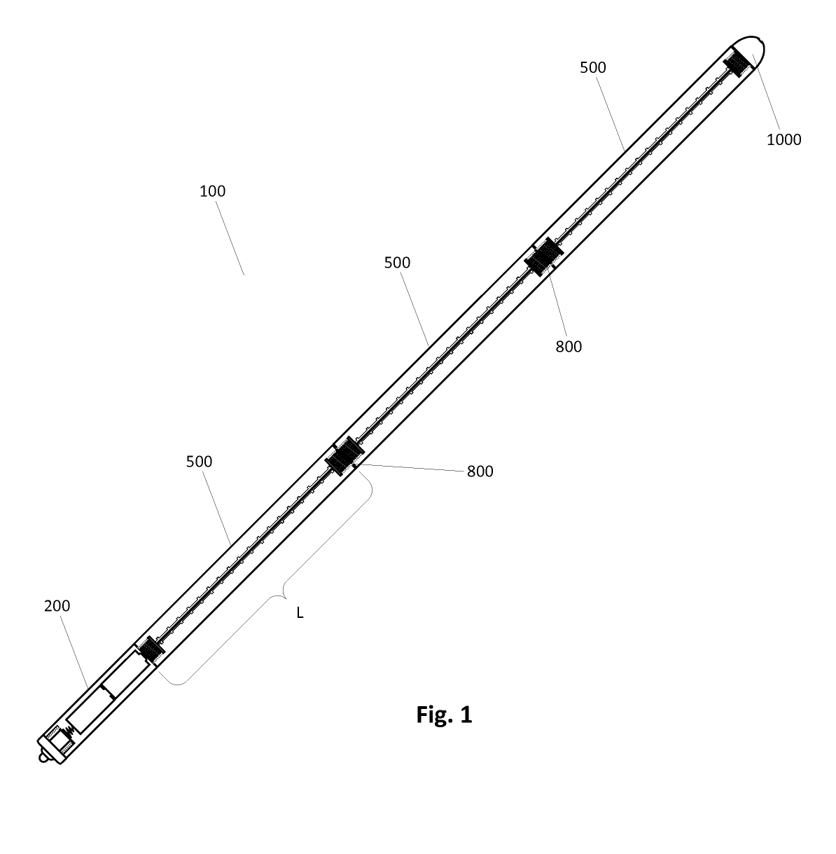

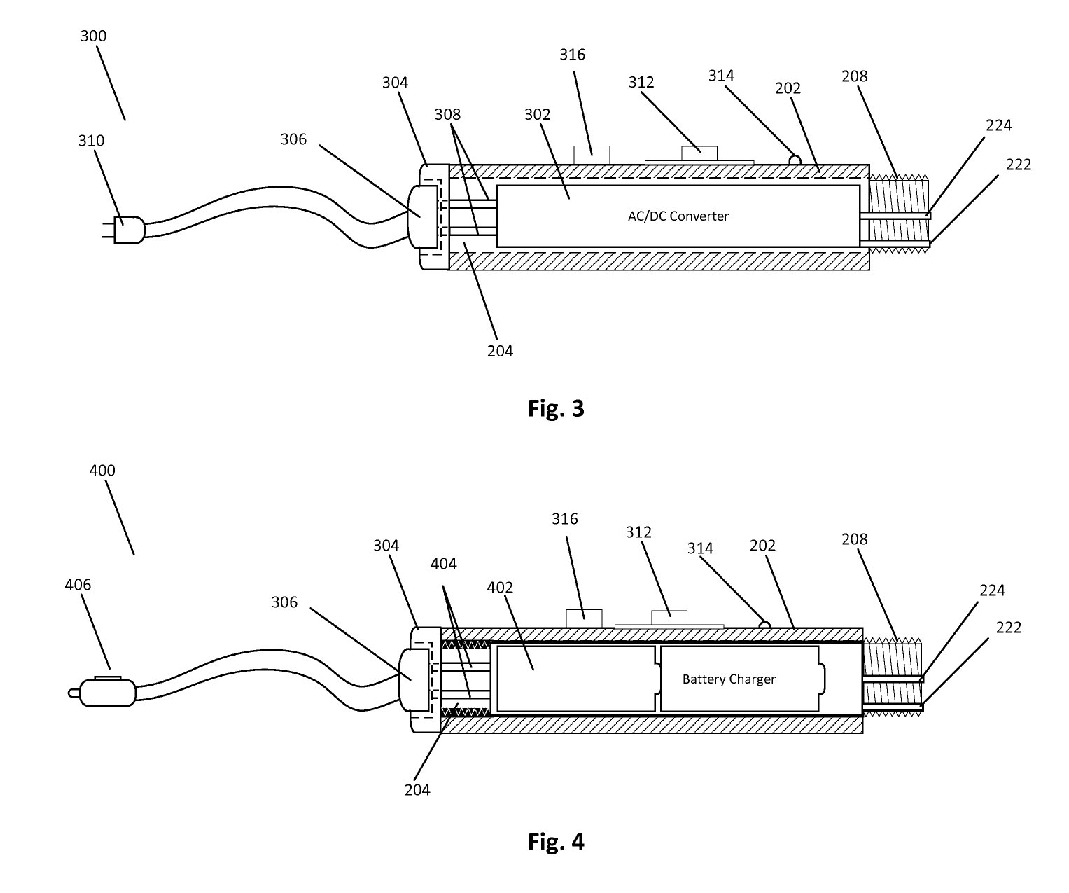

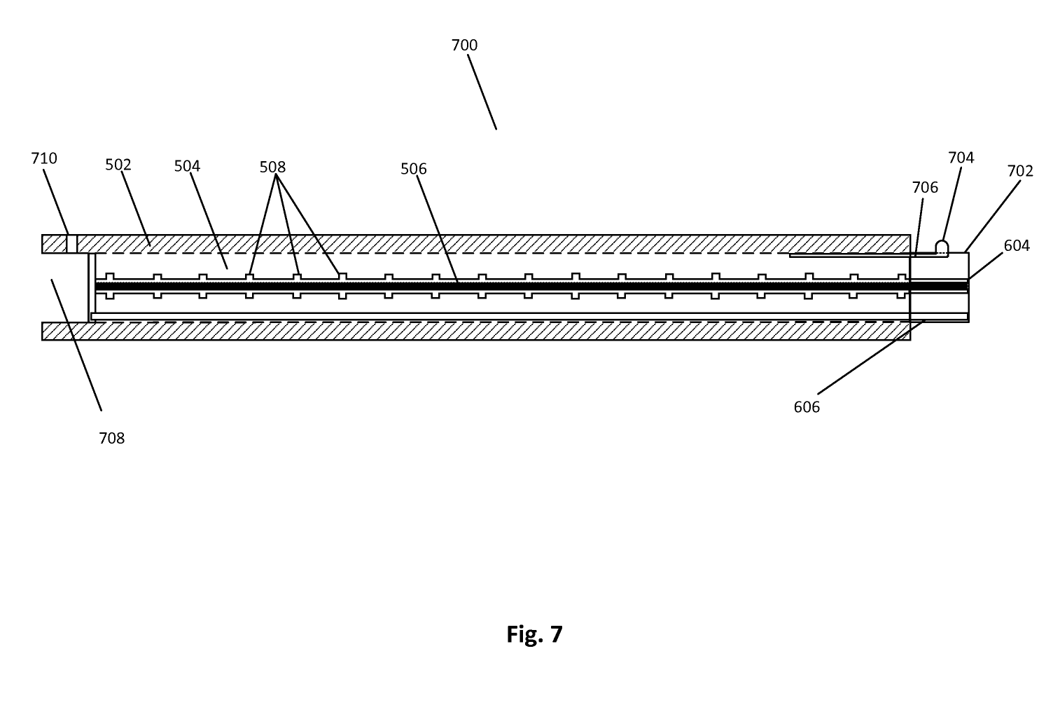

FIG. 1 is a diagrammatic representation of a embodiment of an extendable flex light apparatus. The flex light apparatus 100 may consist of a battery power handle 200, internally threaded light sections 500 each having length “L,” male threaded adapter 800, and a threaded male removable tip 1000. The current embodiment shown in FIG. 1 includes a battery power handle 200, three internally threaded light sections 500, two male threaded adapters 800, and a threaded male removable tip 1000. In other embodiments, the flex light apparatus 100 allows the user assemble a flex light apparatus 100 for a desired application by selecting a battery power handle 200, a desired number of sections, and a threaded male removable tip 1000. The battery power handle 200 is a preferred embodiment of the handle but other alternate embodiments of the handle are described in FIGS. 3 and 4. The internally threaded light section 500 is a preferred embodiment of a lighted female threaded section but other alternate embodiments of the lighted section are described in FIGS. 6 and 7. The internally threaded light section 500 may have a length L wherein one skilled in the art determines the appropriate length. Also, one skilled in the art may determine there may be varying lengths L to accommodate different purposes.

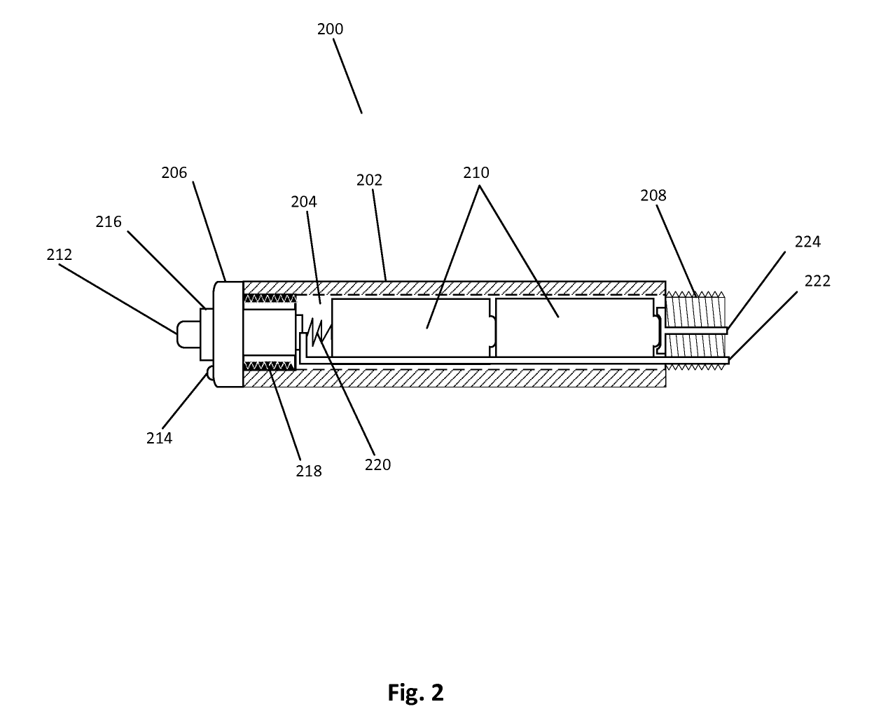

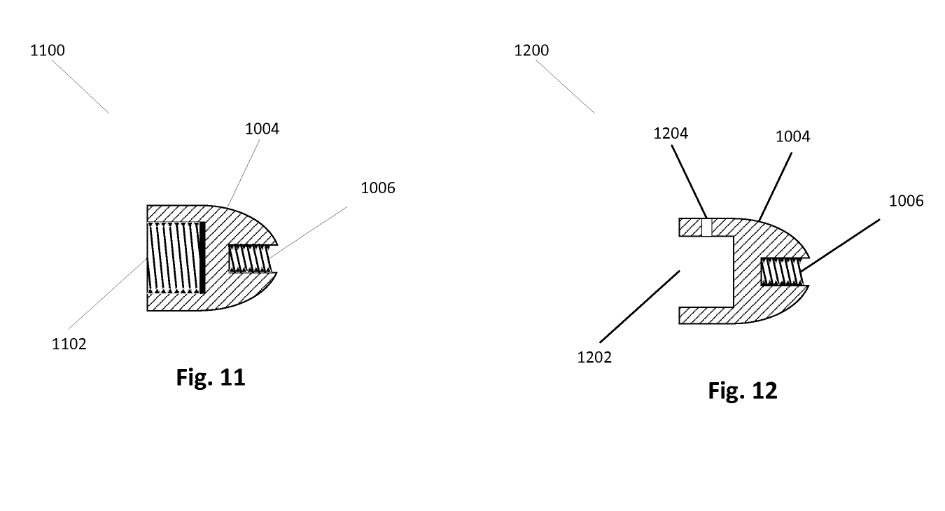

The threaded male removable tip 1000 is shown in FIG. 10 but alternate embodiments are shown in FIGS. 11 and 12. The tip 1000 is capable of receiving different types of accessories that allow the user to configure the flex light apparatus 100 for a number of desired purposes. For example, a user may configure and use the flex light apparatus 100 to provide light behind book shelves and underneath furniture when searching for lost items. Additionally, an electrician may assemble the flex light apparatus 100 with a portable battery power handle 200, multiple internally threaded light sections 500, and a threaded male removable tip 1000 wherein a wire gripper is threadedly attached to the threaded male removable tip 1000. The electrician feeds the apparatus up through the wall into the attic and through the insulation where the lighted section illuminates the area where the flex light apparatus 100 penetrated the attic making it easy for the electrician to find where the wires need to be installed. In this current embodiment, the battery power handle 200 may house batteries, which provides power to light the individual LEDs 509, which may be located on an LED strips 508 along internally threaded light sections 500. At the end of the handle of this embodiment is a power switch 212 and intensity control 216 to activate the LEDs 509 and control their brightness, which will be further described in FIG. 2.

FIG. 2 shows a flex light apparatus battery power handle 200, according to the preferred embodiment of the invention. The battery-powered detachable handle 200 may consist of a housing 202, a housing cavity 204, an end cap 206, a threaded connection 208, a handle battery 210, a spring 220, a ground 222 and a power 224 connection. The end cap 206 may house a power switch 212, a power indicator 214, and a light intensity control 216. The power switch 212 may be selected from one of the following types of switches including toggle, pushbutton, slide, rotary, in-line and rocker but is not limited to these specific switches. The end cap 206 may consist of a male threaded section which threadedly connects to the female threaded end cap retainer 218 inside the housing 202. The end cap 206 is removed from the housing 202 to allow for the installation of at least one handle battery 210. The handle battery 210 is placed inside the housing cavity 204 and pushed to the end where the positive end of the handle battery 210 is in direct contact with the power 224 connection and the negative side of the battery is connected through the spring 220 to the ground 222 that extends outward through a threaded connection 208.

The threaded connection 208 allows the user to mechanically connect multiple lighted sections 500 or 600 to the handle and provide electrical power through the power 224 and ground 222 connections in order to light the LEDs 509 in a section 500, 600. In the end cap 206 as described above, the power switch 212 may be a push button switch or any other type of appropriate switch known to one skilled in the art for providing power to an apparatus. It would be obvious to one skilled in the art to use a female threaded connection instead of a male threaded connection 208 to mechanically connect multiple lighted sections.

Additionally, attached to the end cap 206 may be an intensity control 216 that allows the adjustment of the intensity of the LED strip 508. The intensity control 216 may come in the form of a thumbwheel or a rotary type switch to control the intensity. It would be apparent to one skilled in the art as to other devices that would be able to perform the function of controlling the intensity of the LED strip 508.

The end cap 206 may contain a power indicator 214 to show when the power is on at the power 224 connection. This indicator may come in many forms apparent to one skilled in the arts but the preferred embodiment would be colored LED to show when the power is on. The user would not want to connect internally threaded light sections 500 while the power was applied at the threaded connection 208 through the power 224 and ground 222 connections because of the possibility of shorting or creating a shocking hazard for the user. This embodiment illustrated a portable battery power handle 200 to supply power and provide control to the flex light apparatus 100, wherein the apparatus may be used anywhere with the only limitation being the life of the batteries. Additionally, the apparatus allows for the batteries to be easily and quickly replaced.

FIG. 3 is a view of flex light AC/DC power handle 300 with an AC to DC convertor, an alternate embodiment of the present invention. In this embodiment, the AC/DC power handle 300 is akin to the battery-powered handle in FIG. 200 with modifications. The handle battery 210 inside the housing cavity 204 may be replaced with an AC to DC convertor to provide power to the flex light apparatus 100. The AC/DC power handle 300 is connected to a wall outlet using the AC plug 310 that then supplies power to the end connection 304 through a power cord connection 306. This power cord connection 306 then transfers the AC power through the AC internal power connection 308 to the AC/DC convertor 302 housed inside the housing cavity 204 of the handle housing 202. The AC/DC convertor 302 provides a positive power 224 connection and a ground 222 connection to light the LED strip 508 in an internally threaded light section 500. The AC/DC power handle 300 provides power to an internally threaded light section 500 through a power switch 312. The intensity of the LED strip 508 may be selected by positioning the intensity control 216 on the outside of the housing 202 to a desired level chosen by the user. In addition to both of these controls, there may be a power indicator 214 to alert a user that power is active at the power 224 connection. This embodiment limits the movability of the flex light apparatus 100 to areas where an AC outlet is available, but it provides the added benefit of having constant power to the LED strip 508 and provide a constant lighting whereas in FIG. 2 in the preferred embodiment you could actively go anywhere but you were limited to the power consumption and the battery capacity within the battery power handle 200.

FIG. 4 is a view of a flex light handle with a battery charger, according to an alternate embodiment of the present invention. This embodiment of a battery charger handle 400 with a battery charger 402 positioned inside the housing cavity 204 is similar to the two previous handles and a combination thereof. The battery charger handle 400 has a housing 202 and a housing cavity 204 wherein the battery charger 402 resides within this housing 202. The battery charger handle 400 may be connected to a car cigarette lighter receptacle using a male car cigarette plug 406 allowing the handle battery 210 to be charged while not in use. Additionally, it would be apparent to one skilled in the art that the battery charger 402 may use AC input power for charging the handle battery 210. The male car cigarette plug 406 supplies DC power through the power cord connection 306 through the DC internal power connectors 404 that connect to the battery charger 402.

The battery charger handle 400 has a power switch 312, and may have an intensity control 216, and a power indicator 214 as did the others described above in FIGS. 2 and 3. Additionally, the end connection 304 may be threadedly attached to the housing 202 which allows the end connection 304 to be removed from the housing 202 and the handle battery 210 replaced when it no longer has the capacity to retain a charge. This battery charger handle 400 connects in the same way as the other handles through the male threaded connection 208 providing power through the power 224 connection and a return through the ground 222 connection. Furthermore, the battery charger handle 400 as with the other handles may utilize a quick disconnect as will be described hereinafter in FIG. 7.

As an example, the user, an electrician, of the battery charger handle 400 may connect it to the car's cigarette plug on the way to job site wherein the battery charger 402 charges the handle battery 210 as they are proceeding to the job site. Once they arrive at the job site, they can disconnect the power cord connection 306 from the end connection 304 wherein the battery charger handle 400 would perform similarly to the battery powered handle 200 described in FIG. 2.

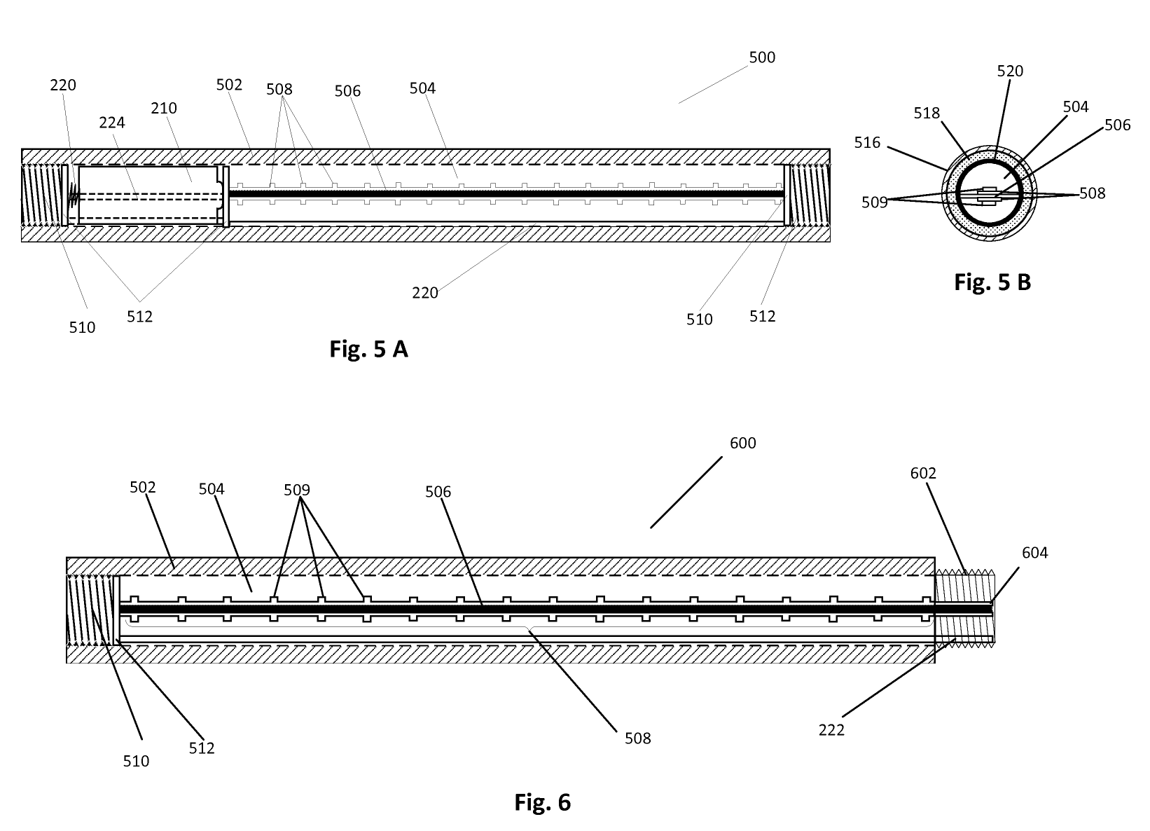

FIG. 5A is a view of a flex light lighted section 500 with threaded female connections according to a preferred embodiment of the present invention. This embodiment is constructed using an elongated shaft 502 with a passage 504, a semirigid member 506 within the passage 504, an LED 508 strip located on within the passage 504 preferably placed on either side of the semi-rigid member 506. The elongated shaft 502 may be constructed using materials including fiberglass, plastic, carbon fiber, polyester, metal alloy and epoxy but not limited to the specific materials. At either end of the elongated shaft 502 are female threaded connections 512 for receiving a male threaded connection 208 from a handle 200, 300, 400, receiving a threaded male removable tip 1000 and receiving a female to male threaded section 600. The handle 200, 300, 400 may have diameter greater than elongated shaft 502 and one skilled in the art may possibly taper to make a smooth transition from the handle 200, 300, 400 to the section 500, 600.

Additionally, the female threaded connection 512 may also receive a male threaded adapter 800 that threadedly connects one internally threaded light section 500 to a second internally threaded light section 500 thereby increasing the overall length of the flex light apparatus 100. Additional internally threaded light sections 500 and male threaded adapters 800 may be added until the flex light apparatus 100 reaches the desired length for the user.

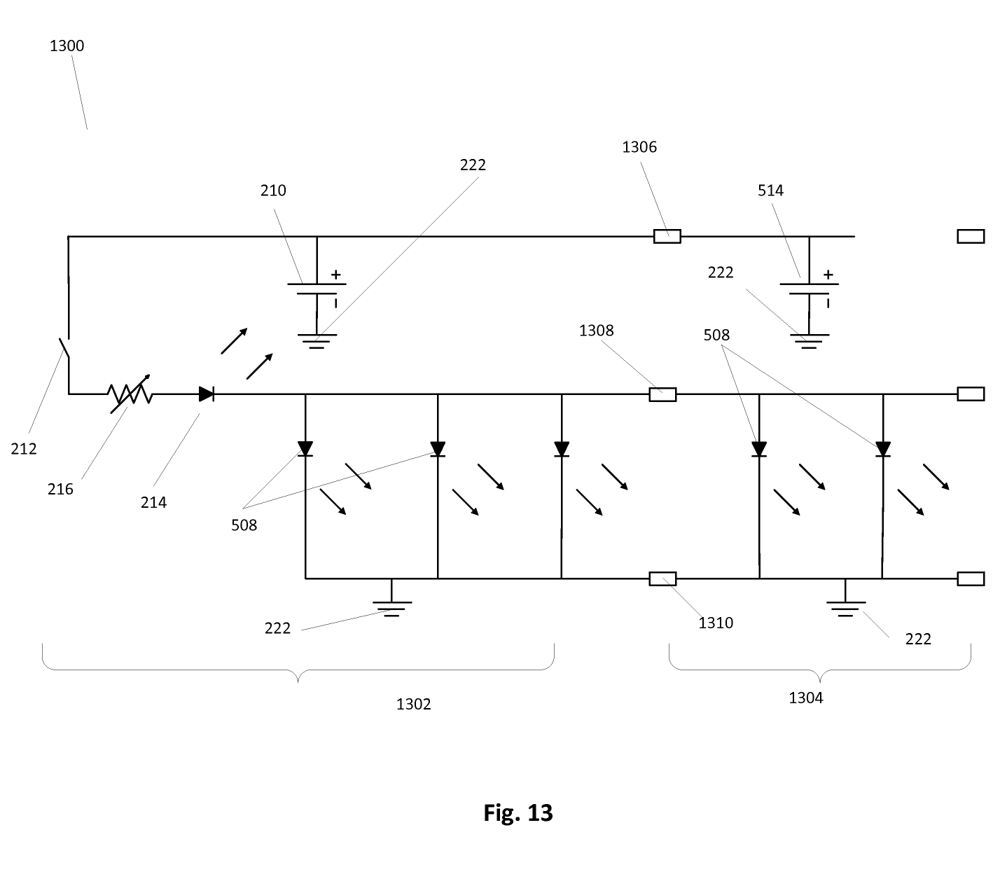

Also contained with inside the passage 504 are two power distribution plates 510. The power distribution plates 510 allow for ground and power to be supplied to the LED strip 508 to light the LEDs 509 and also provides for power to the next internally threaded light section 500 of LED lighting. A section 500, 600, 700, may be configured to house a section battery 514 to provide additional power as more sections 500, 600, 700 are attached. Without the additional section battery 514 in an internally threaded light section 500, the overall flex light apparatus battery life would be reduced causing the user to either reduce the LED intensity to preserve battery life or accept the overall reduction in operating time. In one embodiment that contains only one section 500, the section battery 514 in a section 500 may be removed and the section 500 receive power only from the battery power handle 200. The section battery 514 configuration in an internally threaded light section 500 is similar to the configuration in the battery power handle 200 wherein there is a power 224 connection and a ground 222 connection and a spring 220 that connects the power distribution plate 510 to the negative side of the section battery 514. The handle battery 210 in the battery power handle 200 is electrically connected in parallel with the section battery 514 in an internally threaded light section 500 as is further illustrated in FIG. 13.

In the preferred embodiment, the lighting source is LED strips 508, which are placed on either side of the semi-rigid member 506 and bend with the semi-rigid member 506 as it is manipulated to conform to the desired shape of the user. The lighting source may be selected from a group including incandescent, light emitting diodes (LEDs), neon, and laser but is not limited to theses specific sources of lighting. Additionally, it is preferable that the intensity of the lighting source be adjustable. Multiple LED strips 508 may be installed within the housing cavity 204 to increase the overall light intensity of the internally threaded light section 500.

The semi-rigid member 506 allows an internally threaded light section 500 to be manipulated to a desired shape and retain that shape until the user changes the shape. This allows a user such as an electrician to configure the flex light apparatus 100 to penetrate walls, insulation, and other obstructions when pulling wires. Additionally, it allows a user to place light in a desired location whereas a flashlight and similar type of lighting would not be able to light a desired area due to obstructions or the configuration of the light.

FIG. 5B is an end view of a flex light lighted section 500 showing multi-layered construction. This embodiment of the lighted section 500 may be constructed using multiple layers including but not limited to a protective layer 516, a diffusing layer 518, and a semi-rigid layer 520. The protective layer 516 may be designed to protect a diffusing layer 518, a semi-rigid layer 520, and the internal components such as the LED strips 508 from damage. The diffusing layer 518 may be capable of diffusing the light created by the LED strip 508 and provide more uniform lighting along the length of the internally threaded light section 500. A semi-rigid layer 520 could replace the semi-rigid member 506 or be used in conjunction with the semi-rigid member 506 to provide additional rigidity as desired by the user.

FIG. 6 is a view of a flex light lighted section 600 with a threaded female and male connections according to an alternate embodiment of the present invention. FIG. 6 shows an alternate embodiment wherein one end of the elongated shaft 502 has a threaded female connection 512 and at the other end is a male threaded connection 602. The female-to-male threaded section 600 is similar to internally threaded light section 500 in that it has an elongated shaft 502, a passage 504, LED strips 508 and a semi-rigid member 506 that lie within the passage 504. However, the female to male threaded section 600 includes a threaded male connection 602 to threadedly attaching to another internally threaded light section 500, 600 and provides LED power 604 connection and a ground 222 connection. The LED power 604 connection and a ground 222 connection protrude through to the threaded male connection 602 to contact the power distribution plate 510 in the next internally threaded light section 500 thereby providing power from one internally threaded light section 500 to the next all the way through until multiple internally threaded light section 500 have power.

FIG. 7 is a view of a flex light lighted section 700 with quick disconnect female and male connections according to an alternate embodiment of the present invention. This alternate embodiment with a female-to-male quick disconnect section 700 is similar to the embodiments with a female-to-female connection 500 and a female-to-male threaded connection 600 in FIGS. 5 and FIG. 6. The quick disconnect section 700 has an elongated shaft 502 with a passage 504, a semi-rigid member 506 and LED strips 508 contained with inside the passage 504. Also, contained in the passage 504 is the power distribution plate 510 that provides power to the LED strip 508 and also provides grounding for the circuit. The quick disconnect section 700 has a male mating shaft 702 that would slide into a female receiver 708 to provide a mechanical connection between the two quick disconnect sections 700. Attached to the male mating shaft 702 is a retainer pin 704 and a spring 706 that causes the retainer pin 704 to remain in position in the retainer holder 710 on the female receiver 708 thereby preventing the quick disconnect sections 700 from coming apart until a user desires to separate the quick disconnect sections 700. One skilled in the art may use other devices that are readily apparent for the quick disconnect retaining mechanism. A user may push in the retainer pin 704 to quickly release the retainer pin 704 from the retainer holder 710 to separate the quick disconnect sections 700. A user may quickly assemble several quick disconnect sections 700 to create the desired length of the flex light apparatus 100 and quickly disconnect the sections for ease of transportability and storage.

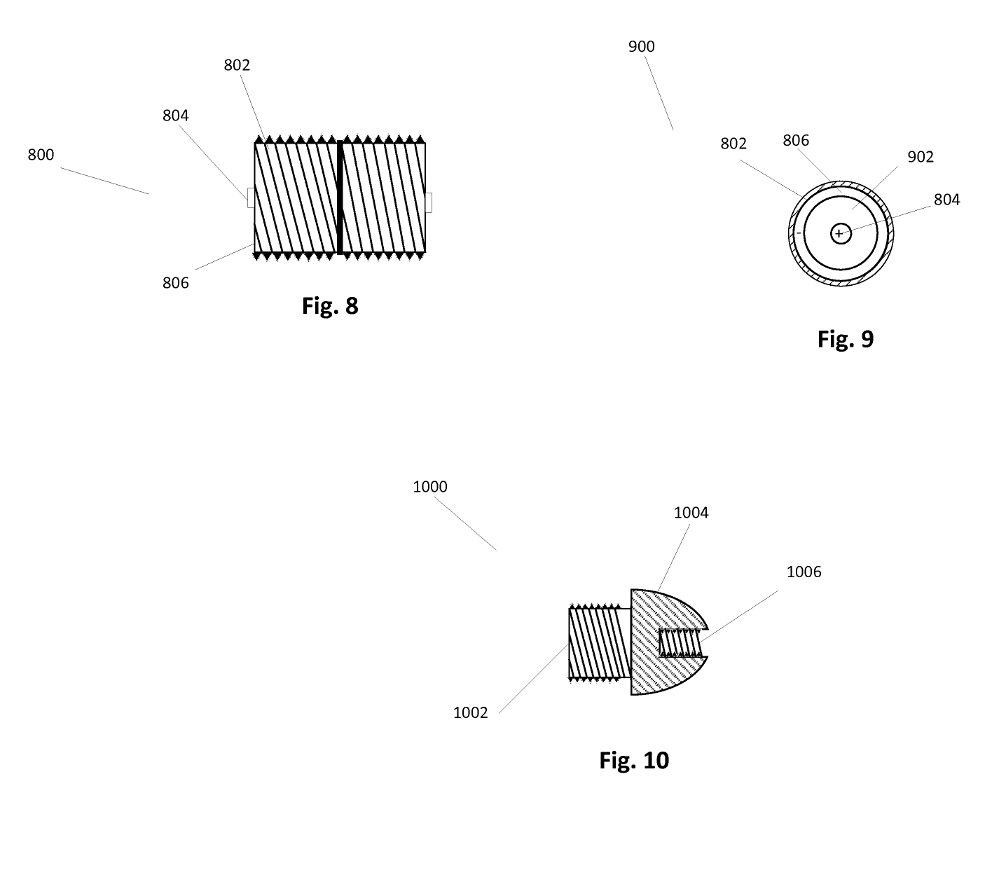

FIG. 8 is a side view of a flex light threaded male adapter 800 for connecting two female internally threaded light section 500 according to a preferred embodiment of the present invention. The male threaded adapter 800 connects female-to-female threaded sections 500 together to create a desired length for the user. The male threaded adapter 800 may have threaded connection 802 running on the outside and along the length of the male threaded adapter 800. This threaded connection 802 may be used to engage the companion threads on the threaded female connections 512 in the end of the internally threaded light sections 500. This threaded connection provides both a mechanical and electrical connection. The male threaded adapter 800 has a power conduit 804 wherein power is supplied by the handle battery 210 up through an internally threaded light sections 500, through the power conduit 804, to additional internally threaded light sections 500, and then returning through the ground conduit 806 to the negative side of the handle battery 210 to complete the circuit and light the LEDs 509 when switched on. It would be readily apparent to one skilled in the art that an adapter may also be a female threaded adapter.

FIG. 9 is a cross-sectional view of a flex light threaded male adapter 800 for connecting two female sections according to a preferred embodiment of the present invention. FIG. 9 further illustrates the male-threaded adapter 800 from a cross-sectional view showing the threaded connection 802, the power conduit 804 and the ground conduit 806. Additionally, FIG. 9 shows a dielectric insulator 900 that separates the power conduit 804 from the ground conduit 806 in order to prevent a short and possible catastrophic failure of the batteries. It would be apparent to one skilled in the art to select the appropriate dielectric material for the varying use of the flex light apparatus 100.

FIG. 10 is a view of a threaded male removable tip 1000 according to a preferred embodiment of the present invention. The threaded removable tip 1000 may be used with the internally threaded light section 500 in FIG. 5 and the threaded female and male section in FIG. 6. The threaded male removable tip 1000 may consist of a male threaded male connection 1002, a round tip 1004, and a threaded attachment point 1006. The threaded male removable tip 1000 may be threadedly attached to an internally threaded light section 500 wherein the threaded male connection 1002 of the removable tip 1000 is screwed into the female threaded connection 512. The threaded removable tip 1000 is rounded which allows it to be maneuvered easily through walls and other obstructions and to penetrate things such as insulation when trying to pull wires. One skilled in the art may choose other shapes depending on the purpose of the flex light apparatus 100. In the round tip 1004 is a threaded attachment point 1006 that allows for different accessories to be threadedly attached to the threaded male removable tip 1000. These accessories may include a hook, a wire grabber, a magnet, and other accessories known to one skilled in the art.

FIG. 11 is a view of a threaded female removable tip 1100 according to an alternate embodiment of the present invention. The threaded female removable tip 1100 may consist of a threaded female connection 1102, a round tip 1004, and a threaded attachment point 1006. The threaded female removable tip 1100 may be a companion piece to the female to male threaded section 600 in FIG. 6 allowing it to be mechanically connected to the section. The threaded female removable tip's 1100 threaded attachment point 1006 as illustrated has the same function as it does in the threaded male removable tip 1000 wherein it utilizes different threaded accessories for different purposes. The accessories for this tip 1100 would be the same as for the tip in FIG. 10.

FIG. 12 is a view of a quick disconnect female removable tip 1200 according to an alternate embodiment of the present invention. The quick disconnect female removable tip 1200 may consist of a female receiver 1202, a retainer holder 1204, a round tip 1004, and a threaded attachment point 1006. The quick disconnect female receiver 1202 allows a male mating shaft 702 to slip into the female receiver 1202 and be retained by the retainer pin 704 mechanically engaging the retainer holder 1204. This tip 1200 is similar to the tips above in that it is a round tip 1004 and also has a threaded attachment point 1006 for the same type of accessories noted above.

FIG. 13 is an electronic schematic of a lighting circuit 1300 according to a preferred embodiment of the present invention. The electrical schematic 1300 illustrates a handle circuit 1302 and a LED section circuit 1304. The handle circuit 1302 is comprised of a battery power handle 200 and one internally threaded light section 500 wherein the circuit may include a battery, switch, LEDs, a ground connection and section connectors. The LED section circuit 1304 may contain a battery, LEDs, a ground connection and section connectors. Power flows from the positive side of the handle battery 210 through a power switch 212 continuing on through the intensity control 216 and power indicator 214 to the LED strips 508 and to the ground 222 completing the circuit. The power switch 212 applies battery power to the LED strips 508 and the intensity control 216 determines the brightness of the internally threaded light section 500.

Additional internally threaded light sections 500 may be attached to the handle circuit 1302. The attachment may require three connections including a section power connection 1306, a section LED connection 1308, and a section ground connection 1310. The power connection 1306 is connected to the positive side of the handle battery 210. This connection provides an electrical connection from the positive side of the section battery 514 to the positive side on the handle battery 210. A ground section connection 1310 provides a connection between the negative side of the handle battery 210 and the negative side of the section battery 514. These connections place the batteries in parallel, keeping the voltage constant, increasing the overall current capacity, and operating time of the flex light apparatus 100. A connection between the LED strip 508 inputs on the handle circuit 1302 and the section LED strip 508 inputs is made through the LED section connection 1308. In this embodiment, the internally threaded light section 500 has a section battery 514 installed wherein current flows from the positive side of the section battery 514 through the power connection 1306 to combine with the current from the handle battery 210 through the power switch 212, the intensity control 216, and power indicator 214 to the LEDs 509 and then to ground 222 causing the LEDs 509 to illuminate. If no section battery 514 is installed all the power will be supplied by the handle battery 210. Additional internally threaded light sections 500 may be added to create the desired length for the user. Section batteries 514 may be installed in each of the sections to keep the intensity of the LEDs 509 at an acceptable level. However the system is designed such that the handle battery 210 may provide power to the LEDs 509 through multiple sections of the desired length but with a possible degradation of the overall brightness of the LEDs 509 as operating time increases. One skilled in the art may find other methods to implement the electrical circuit to allow for controlling the LEDS 509 and adding additional lighting sections.

The purpose of the abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application which is measured by the claims, nor is it intended to be limiting as to the scope of the invention in any way.

Unless defined otherwise, all technical and scientific terms used herein have the same meanings as commonly understood by one of ordinary skill in the art to which this invention belongs. While various methods of use and structures of the present invention are described herein, any methods or structures similar or equivalent to those described herein may be used in the practice or testing of the present invention. All references cited herein are incorporated by reference in their entirety and for all purposes. In addition, while the foregoing advantages of the present invention are manifested in the illustrated embodiments of the invention, a variety of changes can be made to the configuration, design and construction of the invention to achieve those advantages including combinations of components of the various embodiments. Hence, reference herein to specific details of the structure and function of the present invention is by way of example only and not by way of limitation.

While the invention has been shown, illustrated, described and disclosed in terms of specific embodiments or modifications, the scope of the invention is not limited by the precise embodiments or modifications therein shown, illustrated, described or disclosed. Such other embodiments or modifications are intended to be reserved especially as they fall within the scope of the claims herein appended.

Having thus described the invention, I claim:

1. An lighted rod apparatus comprising:
a. a power unit having—
i. at least one switch, and
ii. at least one power source;
b. an elongated shaft having—
i. a leading end,
ii. a tail end,
iii. an elongated section between the ends, the section including at least—
1. a rigidly flexible shaft, and
2. a passage defined within the section; and
iv. at least one light source electrically connected to the power unit and adapted to externally illuminate substantially all of the section,
whereby the lighted rod can be easily shaped to a desired form to illuminate difficult areas and can be manipulated to penetrate areas difficult to illuminate.

2. The apparatus of claim 1, where the power unit is detachable.

3. The apparatus of claim 1, where the switch is selected from a group of toggle, push button, slide, rotary, in-line, and rocker.

4. The apparatus of claim 3, where the switch is adjustable to control the intensity of the light source.

5. The apparatus of claim 1, where the power source is selected from internal and external.

6. The apparatus of claim 5, where the internal power is selected from a battery.

7. The apparatus of claim 5, where the battery is selected from rechargeable and non-rechargeable.

8. The apparatus of claim 5, where the external power is supplied by converting wired power from AC to DC and DC to DC.

9. The apparatus of claim 1, where the elongated shaft is comprised of a material selected from a group including at least one of fiberglass, plastic, carbon fiber, polyester, metal alloy and epoxy.

10. The apparatus of claim 1, where the light source is selected from a group of incandescent, light emitting diodes, neon, and laser.

11. The apparatus of claim 10, where the light source's intensity is adjustable.

12. The apparatus of claim 1, where the leading end is adapted to receive removable accessories.

13. An extensible lighted rod apparatus comprising:
a. at least one power source;
b. at least one switch;
c. more than one elongated shaft having—
i. a leading end,
ii. a tail end,
iii. an elongated section between the ends, the section including at least—
1. a rigidly flexible shaft, and
2. a passage defined within the section,
iv. at least one light source electrically connected to the power unit and adapted to externally illuminate substantially all of the section; and
d. a connection means for releasably mechanically and electrically connecting at least one section to at least one other section,
whereby the lighted rod can be easily extended to a desirable length by adding additional sections and shaped to a desired form to illuminate difficult areas and can be manipulated to penetrate areas difficult to illuminate.

14. An extensible lighted rod apparatus comprising:
a. at least one power source having at least one threaded end;
b. at least one switch;
c. more than one elongated shaft having—
i. a leading end defining a threaded tip adapted to engage at least one selected from a threaded shaft end, a threaded power source, and an accessory,
ii. a tail end defining a threaded end adapted to threadedly engage a threaded tip,
iii. an elongated section between the ends, the section including at least—
1. a rigidly flexible shaft, and
2. a passage defined within the section,
iv. a plurality of LEDs distributed along the elongated section, each LED electrically connected to the power unit and collectively adapted to externally illuminate substantially all of the section; and
d. an electrical connection means for carrying current between shafts, whereby the apparatus may be formed to conform and penetrate into an area to provide light along the entire length of the rod thereby illuminating areas difficult to illuminate.
